(19) United States
(12) Patent Application Publication
(10) Pub. No.: US 2022/0144525 A1
(43) Pub. Date: May 12, 2022

(54) PADDING ARTICLE WITH AGGLOMERATED CANCELLOUS BODY

(71) Applicant: Pregis Innovative Packaging LLC, Deerfield, IL (US)

(72) Inventors: Nileshkumar Amrutiya, Macomb, MI (US); Michael Cuffia, North Richland Hills, TX (US); Jeffery Paul Smith, Bedford, TX (US); Thomas D. Wetsch, Naples, FL (US)

(21) Appl. No.: 17/523,852

(22) Filed: Nov. 10, 2021

Related U.S. Application Data
(60) Provisional application No. 63/112,124, filed on Nov. 10, 2020.

(51) Int. Cl. B65D 81/05; B65D 81/38; B29D 99/00; B31B 50/60

(52) U.S. Cl. CPC B65D 81/053; B31B 50/60; B29D 99/0092; B65D 81/3823

(57) ABSTRACT

The disclosure relates to padding articles comprising a cancellous body formed from an agglomeration of grains made from a polymer material and are bonded together in a cancellous structure. The padding articles provide thermal insulation, sound insulation, cushioning, or a combination thereof. The disclosure also relates to container systems that include the padding articles, apparatuses/methods for manufacturing the padding articles, and methods of use thereof.

### REFERENCE TO RELATED APPLICATIONS

The present application claims priority to U.S. Provisional Application No. 63/112,124, filed Nov. 10, 2020, which is hereby incorporated herein by reference in its entirety.

### FIELD OF THE INVENTION

The present disclosure relates to padding articles that provide, for example, thermal insulation, sound insulation, cushioning, padding, or a combination thereof. Additionally, the present disclosure relates to a process and apparatus for producing the padding articles and methods of using the padding articles.

### BACKGROUND

The shipment or transport of perishable goods requires that such materials remain in excellent condition, often at a stable temperature that may be higher or lower than ambient temperatures to which the package is exposed. For instance, the demand for edible perishables (e.g., fresh foods, beverages, meal-kit delivery services, etc.) has dramatically increased in recent years. Due to the nature of these fresh food products and the desire for off-season supply among consumers, it is may necessary to ship such products from remote locations to virtually every corner of the world. Long transport times for perishable items and the sensitivity of certain items to temperature fluctuations have led to considerable efforts being made to provide shipping containers with insulating characteristics. Yet, many of these efforts have been insufficient and there is a need for improved packaging.

A common material utilized as an insulating packaging material in corrugated containers is expanded polystyrene (EPS) foam, for example as sold under the tradename STYROFOAM®. Although EPS may provide acceptable insulation of perishable goods when used as a liner inside a corrugated shipping box, this material also require a number of undesirable compromises. For example, most packaging systems that use EPS liners require a relatively thick liner of approximately one inch thickness. Consequently, the EPS materials add excess weight to the packaging, which increases freight costs. Further, the overall cushioning effect of EPS in a packaging system is limited. EPS liners therefore consume critical space that could more economically be utilized to ship a greater quantity of commercial product.

In addition, EPS liners require significant amounts of storage space prior to their use in a container, regardless of whether such lines are stored as flat panels or molded containers. Unlike corrugated type cartons, which are usually completely collapsible and can be stored flat and in large numbers without taking up much space, the EPS liners are difficult to store efficiently. Further, EPS presents a health risk as styrene can leach from the material. EPS also poses environmental concerns—e.g., it has been banned from landfills in a number of cities and is not a sustainable product because it is petroleum-based.

Due to the foregoing and other drawbacks of an EPS packaging system, there is a need for thermally insulated packaging systems that do not include an EPS liner. While some such systems have been developed, they tend to be cumbersome, difficult to fold, readily damaged by condensation, costly, and problematic by increasing the overall package weight and decreasing the volume of commercial materials that can be transported in the container. For example, EPS alternatives such as cellulose-based liners, denim-based liners, bubble wrap, non-recyclable plastics, or mixtures thereof suffer from one or more of the foregoing disadvantages.

Hence, there remains a need for improved packaging for perishable materials that provides a highly insulative packaging structure, and that has one or more of the following benefits: lightweight, less costly for storage and shipping purposes, easily foldable, fully collapsible, recyclable and/or produced from recycled materials, and reliable thermal performance over extended periods of time. Such improved packaging is useful in a wide variety of applications, including but not limited to shipping of perishable edibles, sound proofing, and impact reduction (e.g., for shipping containers, vehicles, building and construction materials, protective gear, etc.), among others.

### SUMMARY

In general, the present disclosure relates to padding articles and methods of manufacturing and using the same. The padding article may be foldable and easily manipulated to be placed in a cavity or container for padding, insulation, cushioning, storage, or shipping purposes. In some embodiments, the padding article includes a cancellous body at least partially surrounded by one or more cover layers.

In one aspect, the disclosed technology relates to a padding article, comprising a cancellous body formed from an agglomeration of grains, wherein the grains are made from a polymer material and are bonded together in a cancellous structure.

In some embodiments, the grains are welded together. In some embodiments, the grains are bound together in the presence or absence of a bonding agent. In some embodiments, the bonding agent comprises a polyolefin.

In some embodiments, the grains in the cancellous structure are in a disordered arrangement. In some embodiments, the cancellous structure is an open cell structure. In some embodiments, the open cell structure includes voids that collectively form channels across the cancellous body. In some embodiments, the channels are air channels.

In some embodiments, the polymer material comprises polyolefin. In some embodiments, the polyolefin comprises polyethylene. In some embodiments, the grains have a maximum length in a range of about 0.01 inches to about 2 inches. In some embodiments, the cancellous body has a thickness of about 0.05 inches to about 2 inches.

In some embodiments, the cancellous body is capable of providing thermal insulation, sound insulation, cushioning, or a combination thereof. In some embodiments, the padding article further comprises a cover layer attached to an outer surface of the cancellous body. In some embodiments, the cover layer comprises polyolefin, polyester, or a combination thereof. In some embodiments, the cover layer at least partially surrounds the outer surface of the cancellous body. In some embodiments, the cover layer completely surrounds the outer surface of the cancellous body. In some embodiments, the cover layer is attached by a cover adhesive.

In some embodiments, the padding article comprises at least two connected segments of cancellous body that are hinged to each other. In some embodiments, the cancellous body comprises at least two connected segments that are connected to each other via the cover layer.

In some embodiments, the cancellous body comprises a tapered edge. In another aspect, the disclosed technology relates to a container system comprising a box having a plurality of sidewalls and padding article as disclosed that includes a first segment having a shape closely matching the shape of a first sidewall, such that the first segment is receivable in the box against the first sidewall therein to insulate the first sidewall. In one embodiment, the padding article further comprises a second segment adjacent the first segment, the first and second segments are connected by a hinge, and the second segment has a shape closely matching the shape of a second sidewall, such that the second segment is receivable in the box against the second sidewall therein to insulate the second sidewall. In one embodiment, the padding article further comprises a third segment adjacent the second segment, the second and third segments are connected by a hinge, such that the padding article is configurable into a C-shape, and the third segment has a shape closely matching the shape of a third sidewall, such that the third segment is receivable in the box against the third sidewall therein to insulate the third sidewall.

In another aspect, the disclosed technology relates to a method of manufacturing a padding article, comprising the steps of distributing grains of a polymer having a maximum length in the range of about 0.01 inches to about 2 inches into a generally uniform layer; and bonding the grains together to form an agglomeration of the grains arranged as a cancellous body. In one embodiment, the method further comprises the step of processing the grains from a large piece of the polymer. The step of processing of the grains may comprise grinding, shredding, chipping, or a combination thereof, the large piece of the polymer. In one embodiment, the method further comprises the step of applying a bonding agent to the grains. In one embodiment, grains are bonded together to form the agglomeration using the bonding agent. In one embodiment, the method further comprises the step of molding the agglomeration to shape the cancellous body. In one embodiment, the polymer comprises polyolefin. In one embodiment, the method further comprises the step of applying a cover layer to an outer surface of the cancellous body. In tone embodiment, the cover layer is applied by depositing the grains onto the cover layer and bonding the grains to the cover layer. In one embodiment, the method further comprises the step of molding the grains along with the cover layer to shape the padding article. In one embodiment, grains and cover layer are molded to provide a plurality of segments that are hinged to each other, each segment including a portion of the cancellous body.

In another aspect, the disclosed technology relates to an apparatus for manufacturing the padding article. The apparatus comprises a web feeder that feeds a first cover layer in machine direction; a grain depositor that deposits grains onto the first cover layer being fed by the web feeder; and a mold that molds the deposited grains on the first cover layer to shape the deposited grains and first cover layer as the grains agglomerate as a cancellous body to shape the padding article.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The inventive concepts are described with reference to the attached figures, wherein like reference numerals represent like parts throughout the several views. The figures are not drawn to scale and are provided merely to illustrate the instant inventive concepts, intended for use in conjunction with the explanations provided herein. The figures do not limit the scope of the present disclosure or the appended claims. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operations are not shown in detail to avoid obscuring the inventive concepts.

FIG. 1A is a perspective view of one embodiment of an apparatus used to produce a padding article of the present disclosure;

FIG. 1B is a side view of the apparatus of FIG. 1A;

FIG. 1C is a side view of one embodiment of a padding article of the present disclosure produced by the apparatus of FIG. 1A;

FIG. 2A is a perspective view of another embodiment of an apparatus used to produce a padding article of the present disclosure;

FIG. 2B is a side view of the apparatus of FIG. 2A;

FIG. 3A an isometric view of another embodiment of an apparatus used to produce a padding article of the present disclosure;

FIG. 3B is a side view of one embodiment of a padding article produced by the apparatus of FIG. 3A;

FIG. 4A shows an embodiment of two padding articles;

FIG. 4B shows the assembly of a container system using the padding articles of FIG. 4A;

FIG. 4C is a cross-section view of the assembled container system of FIG. 4B, with items shown inside the container;

FIG. 5 shows ISTA 7E test data of three representative samples of padding articles of the present disclosure compared to a paper-based padding article, as described in Example 1; and

FIG. 6 shows ISTA 7E cold chain summer pack test data of two representative samples of padding articles of the present disclosure compared to a plant-based padding article, as described in Example 2.

### DETAILED DESCRIPTION

The following discussion includes various embodiments that do not limit the scope of the claims. Any examples set forth herein are intended to be non-limiting and merely illustrate some of the many possible embodiments of the disclosure. Further, particular features described herein can be used in combination with other described features in each of the various possible combinations and permutations

The present disclosure relates to advantageous protective articles, including padding articles and methods of manufacturing and using the same. In some embodiments; the padding article are configured to provide; for example; thermal insulation; sound insulation; and/or cushioning, padding, and/or shock protection. The padding articles may be used in any instance where protective or void-fill padding or insulation is desired, such as thermal insulation, sound insulation, and combinations thereof. In certain embodiments, the padding articles may be used for storage and/or shipping purposes. In other embodiments, the padding articles can be configured for use in other industries and applications, such as automotive industry (e.g., for insulation and/or impact protection) or the construction industry (e.g., for insulation of walls, floors, roofs, etc.).

Agglomerated Body

The padding articles disclosed herein comprise agglomerated polymer grains wherein grains or fragments of polymer are bound together to form a body. In some embodiments, the body is a cancellous body having a cancellous structure. In some embodiments, the polymer grains are made from plastic. In some embodiments, the polymer grains may be formed from suitable polymer materials, including but not limited to polyolefin, polyester. In some embodiments, the polymer grains may be formed from polyvinyl, polyurethanes, starches, cellulose, wool, any suitable polymer grains and combinations thereof. Examples of suitable polyolefin for use in the disclosed padding articles include: propylene-based polymer (e.g., polypropylene), ethylene-based polymer (e.g., polyethylene), or a combination thereof. Examples of suitable ethylene-based polymer for use in the disclosed padding articles include: polyethylene foam, polyethylene film, or a combination thereof, including single grade or a combination of different grades of polyethylene. For example, in some embodiments, high-density polyethylene (HDPE), linear low-density polyethylene (LLDPE), low-density polyethylene (LDPE), or a combination thereof may be utilized. The term, “ethylene-based polymer,” as used herein, refers to a polymer that comprises a majority amount of polymerized ethylene monomer (based on the total weight of the polymer), and optionally may comprise at least one polymerized comonomer. In some embodiments, ethylene-based polymer contains more than 50%, 75%, 90% or 95% of ethylene moieties, based on the total weight of the polymer. In some embodiments, the propylene-based polymer is oriented polypropylene (OPP). The term “propylene-based polymer,” as used herein, refers to a polymer that comprises, in polymerized form, a majority amount of propylene monomer (based on the total weight of the polymer) and optionally comprise at least one polymerized comonomer. In some embodiments, propylene-based polymer contains more than 50%, 75%, 90% or 95% of propylene moieties, based on the total weight of the polymer.

Preferably, the polymer grains contain more than 50%, 75%, 90% or 95% of polyolefin, based on the total weight of the polymer grains. In some embodiments, the polymer grains include polyurethane, and the polymer grains contain more than 50%, 75%, 90% or 95% of polyurethane, based on the total weight of the polymer grains.

In some embodiments, the polymer grains may be recyclable or biodegradable (e.g., paper, natural starch, synthetic starch, cellulose, biopolyesters, proteins, polysaccharides, or any other suitable biodegradable material). As used herein, the term “biodegradable” means that a substance decomposes from exposure to light, air, water, or any combination thereof or from the action of naturally occurring microorganisms such as bacteria, fungi and algae. In some embodiments, the polymer grains are primarily made of biodegradable materials. For example, in such embodiments, the polymer grains are made of at least 75%, 85%, or 95% by weight, or substantially entirely of biodegradable materials. In a further embodiment, the padding article, as a whole, is primarily made of biodegradable materials. In some embodiments, the polymer grains may be formed from pre- or post-consumer recycled polymers. In some embodiments, the raw material is provided as blocks or logs of polymer that are processed into grains or fragments. In some embodiments, the polymer starting material is provided as sheets of polymer film or foam that are processed into grains or fragments. In some embodiments, the grains are solid and non-cancellous. In some embodiments, the grains may comprise voids or bubbles within the grains, to give cancellous grains. In some embodiments, the grains may have a lower density than the raw material from which they are made.

The ratio of different polymer starting materials (e.g., HDPE, LLDPE, LDPE) can be adjusted to achieve a desired density of the padding article. For example, increasing the amount of high-density polymer in the padding article will increase the overall density of the article.

Processing the polymer raw material into grains may include shredding, granulating, chipping, or grinding of the polymer into smaller pieces by any suitable means, including but not limited to the use of: manual or automated granulators, grinders, or shredding devices, hand tearing, scissors or shears, guillotine, laser, mill grinder, mortar and pestle, and the like. The method(s) of shredding, granulating, chipping, or grinding employed can be selected based on the starting materials and the desired size of end product pieces.

The size of the polymer grains may be measured in terms of their maximum length, whereby the maximum length is the longest surface length of a grain, regardless of its orientation. The size of a polymer grain may generally be as small as about 1/32 of an inch, or about 1/16 of an inch or about ⅛ of an inch, to as big as about 5 inches or about 2 inches, or about 1.5 inches, or about 1 inch or about 0.5 inches. In some embodiments, the grains may be about 0.25 inches. The polymer grains may be generally homogenous in size or the size distribution may vary—e.g., up to about 75%, up to about 85% or up to about 95% of the polymer grains may have a maximum length in the range of about 0.5 inches to about 1.5 inches. In some embodiments, the grains may be heterogeneous in size.

In some embodiments, the shape of the grains can be generally homogenous or heterogeneous. The shape of the grains varies depending on the method of processing the grains and the raw material used. The size and shape of the grains can be selected based on the desired size of the voids between the grains and the desired density of the padding article. For example, smaller grains will give smaller voids and a higher density padding article than larger grains, which will form a more cancellous structure with a lower density.

In some embodiments, the grains are combined and agglomerated in a substantially disordered arrangement, in which the agglomerated grains include varied, random orientations, to form a cancellous structure with voids between the grains. In some embodiments, the cancellous structure may be an open cell structure, wherein voids between the grains form channels throughout the cancellous body. In some embodiments, the channels that are formed throughout the cancellous body are air channels. In some embodiments where the covers aren't sealed around the core, the channels can be open to the exterior/atmosphere. In other embodiments, the channels may contain a fluid or combination of fluids. In other embodiments, the cancellous structure may be a closed cell structure, comprising discrete pockets of gas, air, or other fluid between the grains. In further embodiments, the voids may be filled to generate a non-cancellous body.

Batches of polymer grains made from different polymer starting materials or by different methods may be combined to generate the body. For example, grains produced from shredding polyolefin film may be mixed with additional grains produced from ground polyolefin foam. In some embodiments, the grains are mixed to aerate the cancellous body and generate a cancellous structure. The mixing process may be performed by any suitable means, including but not limited to hand mixing, commercial stand mixers, cement mixers, double cone mixers, drum mixers, agitators, and the like. Batches of grains may be mixed for different lengths of time. For example, if different batches of different raw materials are combined, mixing may need to be conducted for a longer period of time or more vigorously than if batches of the same raw material are combined. In some embodiments, the polymer grains include a single type or grade of polymer.

In some embodiments, additional components are added to the polymer grains before, during, or after mixing. Such additional components may include one or more bonding agents, dyes, water, fire retardants, mineral hydraulic binders, fillers, and combinations thereof.

In some embodiments of the padding article, the body is formed by agglomeration of the polymer grains that form the body, wherein the polymer grains are bonded or attached together. While in some embodiments, bonding of the polymer grains is performed in the presence of a bonding agent, in other embodiments the bonding of the polymer grains is performed in the absence of a bonding agent.

Suitable bonding agents are selected based on the composition of the grains to be bonded. The bonding agent may comprise a liquid, solid or gaseous binding agent. Depending on the material of the grains, suitable bonding agents can include an adhesive, such as an acrylic, a hot melt, a latex, a polyvinyl chloride, a pressure sensitive adhesive, a styrenated acrylic, styrene butadiene, vinyl acetate, ethylene vinyl acetate, vinyl acrylic, a melt-fusible fiber, a partially meltable bicomponent fiber (e.g., PE/PP, PE/PET, specially formulated PET/PET), cellulose, starch, like materials, and combinations thereof. The bonding agent may include a polyolefin-based adhesive or a polyolefin dispersion, that can be used in combination with polyolefin grains. The polyolefin dispersion can include polyethylene and/or polypropylene, and/or other suitable thermoplastic, a polymeric stabilizing agent comprising at least one polar polymer, and water. One example of a suitable polyolefin dispersion includes HYPOD® manufactured by Dow Chemical Company. Other combinations of grains and bonding agent include cellulose based grains with starch based adhesive, or polyethylene based grains with polyethylene based adhesive for example. Other suitable combinations exist.

In some embodiments, the bonding agent may be waterproof. In some embodiments, the bonding agent may be a sealant when heated or chilled.

In some embodiments, the bonding agent is added to the polymer grains and then the combined materials are mixed to form the body. In other embodiments, the bonding agent is added to the polymer grains after they have been mixed to form the body. In some embodiments, the bonding agent is sprayed onto the surface of the polymer grains as the grains exit a grinder, shredder or other means for forming the grains. In other embodiments, the bonding agent is applied as a top layer over the polymer grains after the grains have been arranged into a layer.

Different amounts of bonding agent may be used. In some embodiments, the bonding agent is applied in an amount that lightly coats the grains. In another embodiment, the bonding agent is applied in an amount that substantially fills the voids between the grains. In some embodiments, the bonding agent may be applied to the surface of the grains and then foam up to fill the voids.

When the polymer grains are bonded in the absence of a bonding agent, they may be bonded together by chemical and/or mechanical means. For example, depending on the material from which the grains are made, the grains may be bonded together by heat adhesion—e.g., heating the grains to their glass transition temperature, causing the surface of the grains to soften or melt, and to then adhere to each other under pressure. Different temperatures and/or pressures may be used depending on the polymer starting material. Heating may be achieved by baking, hot air, ultrasound, radio frequency exposure, or welding, such as thermal, ultrasonic, or friction welding, among other suitable means. In other embodiments, the grains may be bonded together by chemical adhesion (e.g., chemical fusion), using a solvent to change the molecular properties of the surface of the grains such that the grains bond together when the chemical is removed.

Whether a bonding agent is used or not, the bonding of the polymer grains should be suitable to generate the density of padding article required. For example, a bonding agent may be used such that the bonding agent fills the voids between the grains and forms a non-cancellous structure with higher density. In other embodiments, the method of bonding allows for larger voids, providing a lower density cancellous body. The cancellous structure allows for the presence of gas (e.g., air) within the cancellous body and provides for advantageous properties of reduced density, reduced weight, cushioning, and insulative ability, including one or more of thermal, sound, and impact insulation.

In some embodiments, the agglomerated body is processed and configured to obtain a desired degree of cancellousness to provide the intended properties of the padding article. For instance, the shape and size of the grains and/or the process by which the grains are removed, the bonding agent selected and its method of application, the molding of the agglomerated body, and the other steps in forming the agglomerated body can be adjusted to obtain the desired degree of cancellousness. The density of an agglomerated cancellous body made according to some embodiments can may be, for example as low as about 5%, 10% or 20%, or below about 50%, 70%, or 80% of the density of the raw material from which the grains were obtained or of the density of the grains themselves that are agglomerated to form the agglomerated body. The process and configuration of the agglomerated body can also be selected to obtain a ratio by volume of void space to agglomerated grain structure as low as about 5%, 10% or 20%, or below about 50%, 70%, or 80%. Other densities and void-space ratios can be obtained in other embodiments.

Cover Layer

In further embodiments, the padding article may comprise one or more cover layers attached to an outer surface of the body. In the cover layer is provided from a cover layer supply, that may comprise a roll of cover layer, a stack of fan folded cover layer, or individual sheets of cover layer. In some embodiments, the cover layer is placed in a mold or tray. In some embodiments, the cover layer is more flexible than the body. In some embodiments, the cover layer comprises one or more film or foam sheets. In other embodiments, the cover layer may comprise one or more discrete sheets. In another embodiment, the cover layer may be a skin that is sprayed onto the body. The cover layer may also be attached to the outer surface of the body by means of heat-sealing, heat-welding, sonic-welding, lamination, static cling, and stitching. Other means for attaching the cover layer include the use of one or more cover adhesives, such as tapes, glues, or hot-melts. In some embodiments, the cover adhesive may be a bonding agent, such as those described herein for use in bonding the polymer grains of the body together.

In some embodiments, the cover layer includes a web of suitable material, such as a film sheet having a thickness of about 0.0001 inches to about 0.01 inches, about 0.0005 inches to about 0.005 inches, or about 0.001 inches to about 0.003 inches. In some embodiments, the cover layer includes a foam sheet having a thickness of about 0.01 inches to about 0.5 inches, about 0.03 inches to about ¼ inch, or about 0.05 inches to about ⅛ inch. In other embodiments, several inches of foam sheet can be used. In general, the width and thickness of the cover layer may be substantially consistent along its length, although variations of thickness and width are permissible in some embodiments, e.g., due to inherent variation and standard deviation caused by manufacturing processing.

The cover layer may be made of any suitable material. In one embodiment, the cover layer is made of a polymer material, including but not limited to polyolefin and polyester. In some embodiments, the cover layer is made of polyethylene, polypropylenes, polyvinyl, polyurethanes, starches, cellulose, wool, any suitable cover layer material and combinations thereof. In some embodiments, the cover layer may be recyclable or biodegradable. Examples of suitable polyolefin for use in the cover layer include: polypropylene, polyethylene, or a combination thereof. Examples of suitable polyethylene for use in the cover layer include: polyethylene foam and/or polyethylene film, including single grade or a combination of different grades of polyethylene. For example, in some embodiments, HDPE and/or LDPE may be utilized. In some embodiments, the cover layer includes metalized polymer, such as metalized polyethylene. In other embodiments, the cover layer may be made from paper, for example, cardboard, corrugated paper constructions, Kraft paper, fiberboard, pulp-based paper, recycled paper, newsprint, and coated paper such as paper coated with wax, plastic, water-resistant material, and/or stain-resistant material. In general, the material from which the cover layer is made is consistent throughout the cover layer, although variations in composition are possible in some embodiments. The cover layer may be made from recycled material and/or otherwise be recyclable. The cover layer may be moldable and cuttable. The cover layer may be resistant to undesirable effects of condensation.

In one embodiment, one outer surface of the padding article may have a film cover layer and another outer surface (e.g., an opposing outer surface) of the padding article may have a foam cover layer. Alternatively, both sides of the padding article may have a film cover layer, or both sides of the padding article may have a foam cover layer. In further embodiments, only one outer surface of the padding article has a cover layer.

In some embodiments, the cover layer comprises a monolayer, for example a single layer of polyethylene foam. In other embodiments, comprises multiple layers to form a multi-layer cover layer. Each of the multiple layers of a multi-layer cover layer may include one or more material. The multi-layer cover layer may include layers of the same material or combinations of layers comprising different materials. For example, one or more of the layers of the multi-layer cover layer may include polyethylene foam. Multiple layers of the multi-layer cover layer may or may not be sealed together. If multiple layers are sealed together, they may be sealed using an adhesive or a tie layer between adjacent layers. In some embodiments, multiple layers of the multi-layer cover layer are coextruded together. In some embodiments, the multi-layer cover layer includes a barrier layer that is impervious to fluid. In some embodiments, the multiple layers can include one or more seal layers. One example of a suitable seal layer may be used to seal adjacent multi-layer cover layers. In some embodiments, a monolayer cover layer and multi-layer cover layer can be used in combination, for example, on opposing outer surfaces of the body.

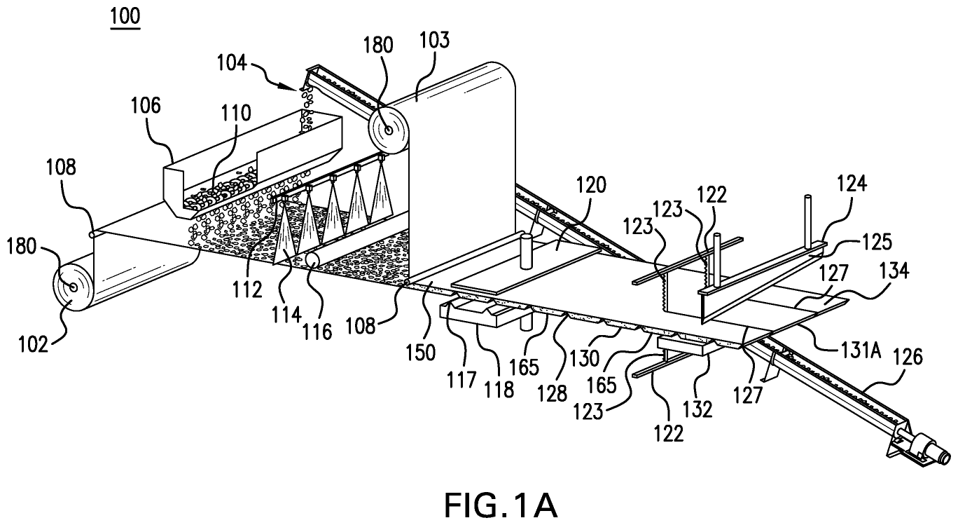

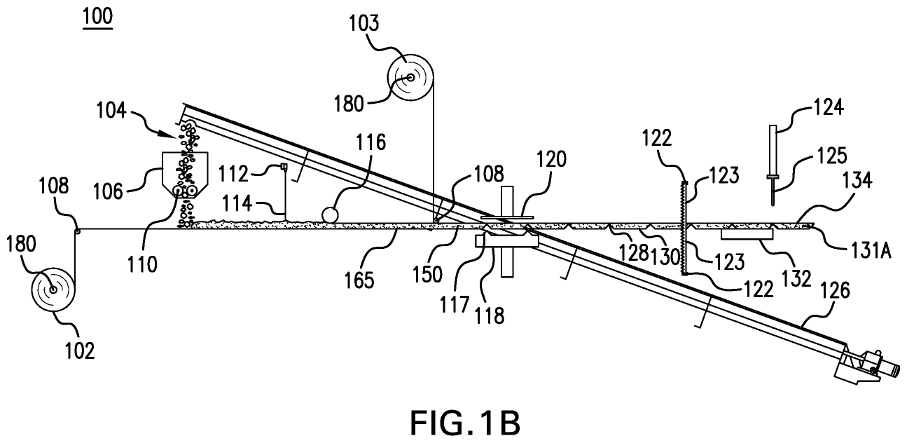

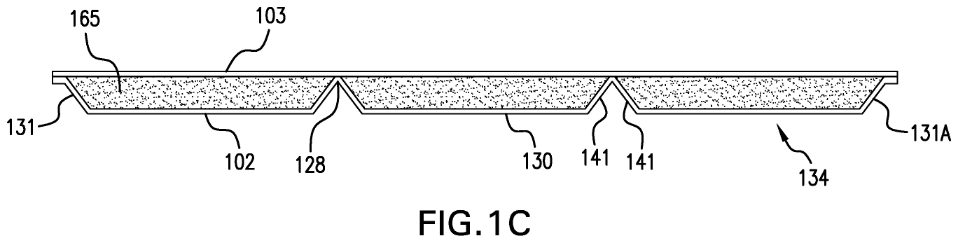

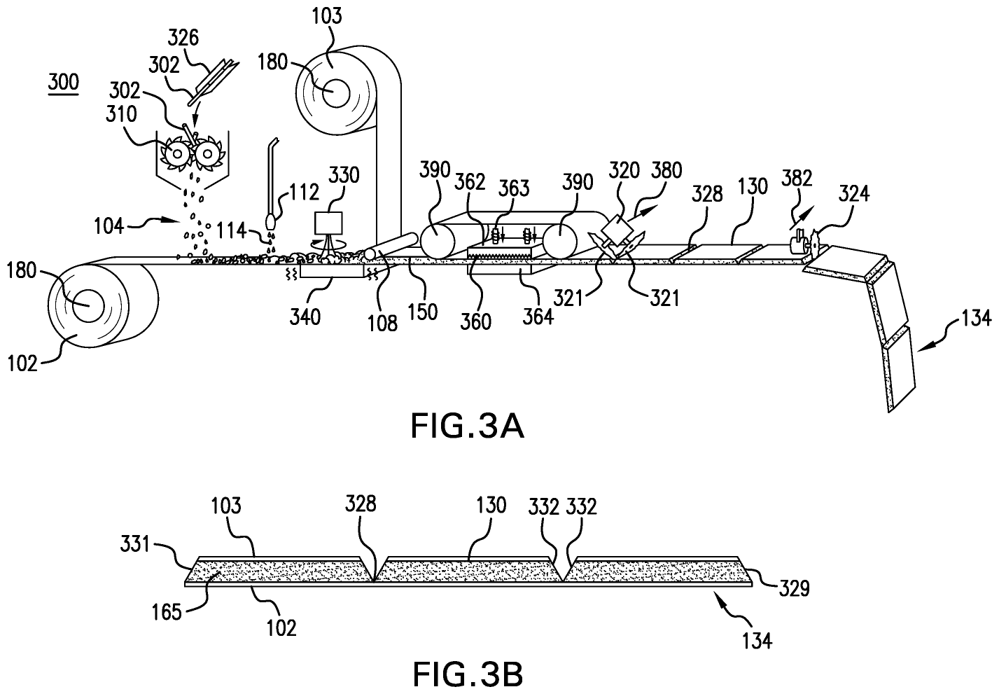

In some embodiments, the tapered cover layer edges 131 and 199 are symmetrical or asymmetrical with respect to the body. For example, the end of the taper may fall in the center of the depth of the body. In other embodiments, as illustrated in FIGS. 1C and 7, the tapered end may be asymmetrical, with the end of the taper aligning with the plane of the padding article on one side only. In other embodiments, one or more of the cover layer ends may be flat 329, 331, as illustrated in FIG. 3B.

The seals may generally be provided in any manner capable of bonding together layers of the cover layer, including but not limited to adhesives, tapes, glues, hot-melts, thermo- or heat-sealing, thermo- or heat-welding, sonic-welding, lamination, static cling, and stitching among others. In one embodiment, the seals are provided as a hot melt glue, for example, a pressure sensitive adhesive (PSA) such as a hot-melt PSA or another type of PSA. In one embodiment, the seals are provided as a polyolefin adhesive. In some embodiments, the seal material is recyclable. In some embodiments, the seals are provided at the molding stage.

As described above, the cancellous structure allows for the presence of gas (e.g., air) within the cancellous body and provides for advantageous properties of reduced density, reduced weight, cushioning, and insulative ability, including one or more of thermal, sound, and impact insulation. In some embodiments, the cover layer will also add to these advantageous properties by helping to reduce air flow through the cancellous body. In addition, in some embodiments, a metalized cover layer will improve thermal insulation by acting as a radiant barrier.

In some embodiments, the padding article is configured to provide low thermal conductivity and high thermal resistance (R-value) to achieve optimal thermal insulative properties. For example, if the body is used in a container to transport a temperature-sensitive product, heat transfer will be reduced and the desired temperature of the product will be maintained for an extended period, reducing the effect of ambient temperature outside the container for an extended length of time e.g., at least 24 hours, at least 48 hours, at least 72 hours, etc.

In some embodiments, the padding article is configured to prevent sound waves from permeating through the padding article, thereby providing sound insulation. For example, if the padding article is used in the walls of a recording studio, it can minimize the sound waves that exit the studio padding.

In some embodiments, cushioning properties of the padding article allow for protection of items that could be damaged by normal shipping or handling processes that may include vibration and shock impact. In some embodiments, the padding article will absorb shock and dampen vibration rather than transmitting the shock or vibration to the protected items. Embodiments of the padding article used in applications such as helmets or car doors allow for improved shock absorption, reducing impact to the user.

Padding Article Segments

In some embodiments, the padding article comprises one or more segments. The segments may be delineated by hinges that extend across the padding article in a transverse direction between adjacent segments. In some embodiments, the hinges may extend in a longitudinal direction. In further embodiments, the indentations may extend in other or combinations of directions, including longitudinal, transverse, and/or diagonal for example, allowing for the segments to be folded in different configurations.

In some embodiments, the hinges are living hinges formed extending across the padding article to provide a naturally flexible hinge line thereacross. The living hinges can be provided by forming a line that is more easily bendable, or has weaker resistance against bending, than the adjacent segments of the article. Such living hinges, for example, can include indentations that extend through the core and/or cover layer(s), a discontinuity in the core where there is a continuous cover layer or where opposite cover layers are continuous, or in embodiments in which the cover layer is stiffer than the core, a discontinuity in the cover layer(s) where the core is continuous.

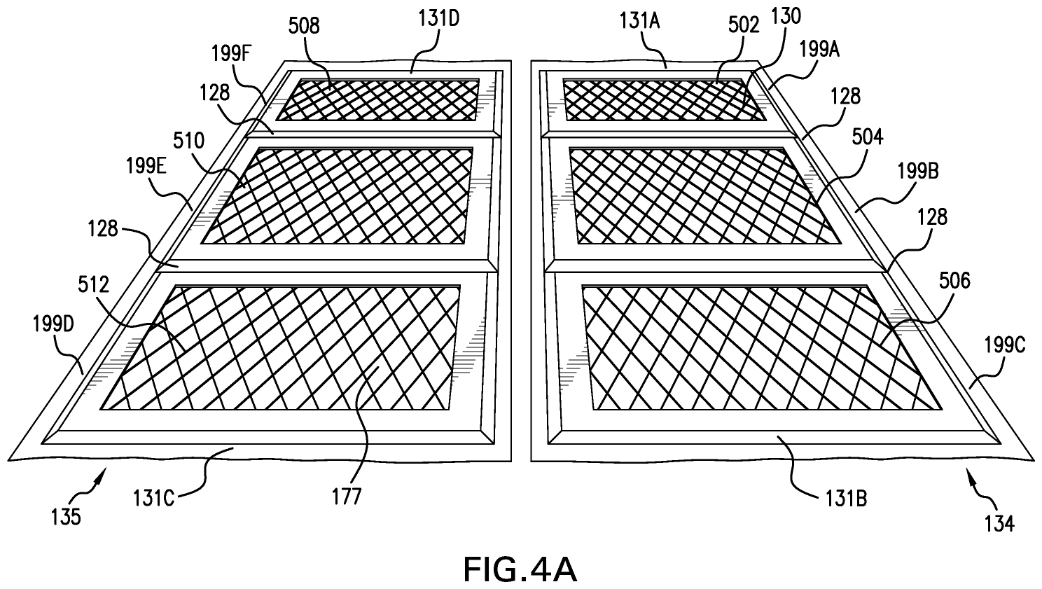

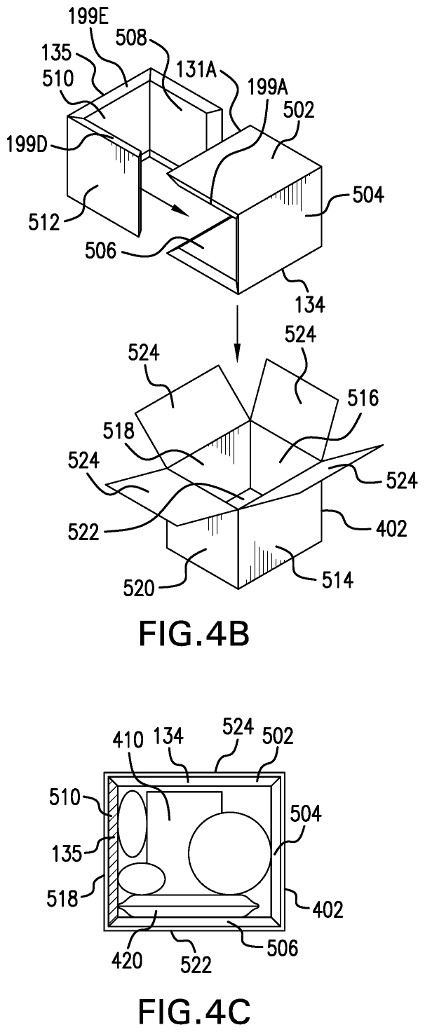

The edges of the segments can be chamfered 141, 332 on one or both opposing principal surfaces of the core or article, thereby providing a chamfer extending into the hinge that enables folding of one segment with respect to the other towards the chamfered side of the padding article. The chamfers of the embodiments shown in FIGS. 1C, 3B, and 4A are v-shaped in cross-section 128, 328 and of sufficient depth to enable the respective segments to be pivoted or swung from a coplanar orientation as in FIG. 1C and FIG. 3B, to a mutually perpendicular orientation as in FIG. 4B, whereby the padding article may be readily folded into a box-like assembly and used as a container, or fitted into a similarly shaped container as shown in FIGS. 4B and 4C. The chamfered surfaces are provided in the longitudinal ends of both segments abutting the hinge in these embodiments, which in other embodiments the chamfer is provided at the edge of only one segment.

The hinges may be formed by various techniques, such as by cutting, chamfering, abrading, using a water jet, cutting blades, lasers, melting, or molding and applying pressure and/or heat. In some embodiments, the indentations are made by forming two angled chamfers or cuts into the surface of the padding article to form an indentation having an angle of about 30° to about 60°, about 40° to about 50°, or about 45°. In general, the angle of the chamfer or cut allows for the adjacent segments of the padding article to be folded to an angle of about 60° to about 120°, about 75° to about 105°, or about 90°, for example.

In some embodiment, the segments may be separated by lines of weakness or perforations, allowing the segments to be manually separated from each other by a user, after which segments can be manually arranged at desired angles. One or more lines of weakness or perforations may be located within or adjacent to one or more indentations or hinges.

In some embodiments, the segments may be indirectly connected via a cover layer, wherein the indentations or hinges may be formed by cutting or shaping entirely through the thickness of the body, but such indentations do not extend through the cover layer or extend through only a portion of the cover layer. In some embodiments, the portions of cover layer between the segments of the padding article create a living hinge.

In another embodiment, the padding article segments are formed from discontinuous panels and are indirectly connected via sections of cover layer that are attached to an outer surface of the body of each panel. In such an embodiment, the cover layer serves to hold the separate panels in place within the structure of the padding article. The distance between adjacent panels can be adjusted based on the size and angle of the living hinge formed by the portion cover layer positioned between the panels.

Padding Article

In some embodiments, the padding article may be generally rectangular in shape. In other embodiments, the padding article may be a cross shape, or any other shape that can be folded to form a box, whether alone or in combination with other padding articles. In one embodiment, the padding article comprises three segments in tandem, forming a rectangular shape. In one embodiment two rectangular padding articles are used in combination to form a box shape, whereby each of the two segmented padding articles is foldable into a C-shape and the two articles are slotted together to form a six-sided box, as illustrated in FIGS. 4A and 4B, for example. In the embodiment, the longitudinal edge 131a of the article 134 corresponds to the transverse edge 199e of the article 135, thereby forming a tight seal. Similarly, the transverse edge 199a of the article 134 corresponds to the transverse edge 199d of the article 135, forming a tight seal. Each pair of corresponding edges of the articles 134 and 135 are joined together to form a six-sided box 402. In other embodiments, the padding article can be a cross-shape comprising six segments that can be folded into a six-sided box. In some embodiments, each segment is square shaped. In some embodiments, the padding article has two segments that can be folded and sealed along opposing lateral edges to form a pouch.

When the padding article is used as a liner inside a six-sided box, each segment may have a shape and dimensions closely matching the shape and dimensions of one of the inner sidewalls of the box. For example, if two rectangular padding articles are used, each may be folded into a C-shape and fitted together to form a box, as illustrated in FIG. 4B for example. One padding article will fit against three sides of the box, and the other padding article will fit against the other three sides of the box. The segment of the padding article that fits against the top of the box, can be opened and closed to allow a user to easily remove the contents of the box without having to remove the padding article. If a cross-shaped padding article is used, each of the six segments may be shaped to match and fit against each of the corresponding six sides of the box. In some embodiments, the segment shape and dimensions are substantially the same as the corresponding inner sidewall shape and dimensions so as to effectively provide the desired thermal insulation, sound insulation, and/or cushioning, to the items inside the box.

The thickness of the body may generally be in the range of about 0.05 inches to about 2 inches, about 0.1 inches to about 1 inch, about 0.25 inches and about 0.5 inches. For example, in various embodiments, the thickness of the body may be about 0.05 inches, about 0.1 inches, about 0.25 inches, about 0.5 inches, about 1 inch, about 1.5 inches, or about 2 inches. In general, thicker padding articles are more insulative (i.e., provide more thermal insulation, and/or sound insulation) and can provide increased cushioning than thinner padding articles.

The padding article may be formed from a semi-rigid material, or from a flexible material that can be folded into a box or container shape without the need for indentations or hinges between segments. All or some parts of the padding article may be made from recyclable materials. For example, in such embodiments, the padding article is recyclable at least 80%, 85%, 90%, or 95% by weight. In some embodiments, all parts of the padding article are made from recyclable material.

In some embodiments, the disclosed padding article may be used with a container or other item having a cavity in which the padding article may be place. Examples of containers that may be used with (e.g., lined with) the disclosed padding article include storage containers and shipping containers. In one embodiment, the container is a six-sided, rectangular or cuboidal box. Typical containers may be made from plastic, cardboard, fabric, or any other suitable material. Other examples of containers include a wall, flooring, or other item requiring insulation or cushioning. In some embodiments, the padding article may be pre-shaped into the size and shape of the container or cavity with which it is to be used. In other embodiments, the grains that form the cancellous body may be deposited into the container or cavity to fill the container or cavity, and are then agglomerated therein to form the cancellous structure of the cancellous body.

The padding article may be compactly arranged and retained in a coplanar conformation for storage and/or shipment when not in use with a container. Prior to use (e.g., with a container), the padding article can be efficiently transported and stored, providing for reduced costs. After use, the padding article may be easily broken down, flattened, reused, and/or recycled.

Manufacturing Methods

The present disclosure also relates to methods of manufacturing the disclosed padding articles. Some such methods include several steps that may be performed consecutively, in various orders, or at multiple locations. For example, different parts of the padding article may be manufactured at different locations and combined at a separate location. The different steps may be performed manually by one or more workers, as part of an automated system, or as a combination thereof.

Some embodiments of the method of manufacture of the padding article include, but are not limited to the steps of: processing of polymer material into polymer grains; mixing of the grains; distribution and levelling of the grains into a uniform layer; applying or attaching a cover layer; agglomerating the grains together to form the padding article; cooling the padding article; forming indentations or hinges in the padding article; assembling the padding article into containers or into coplanar configurations for distribution. Some or all of these steps may be performed in any order or combination that results in the desired padding article. For example, the indentations or hinges may be formed before, during, or after the agglomeration step. In another embodiment, indentations or hinges may not be formed during the manufacturing process, or may be provided by an end user.

FIGS. 1A and 1B illustrate one embodiment of a padding article forming apparatus 100. As shown in these figures, polymer grains 104 are delivered via conveyor 126 into a grain depositor such as a distribution head box 106, comprising twin augers 110 configured to evenly distribute the polymer grains transversely onto a cover layer 102. The grains 104 are deposited into a layer in a disordered arrangement to leave voids between the grains, at a thickness greater than or about the same size of the thickness of the desired padding article 134. The grains 104 are generated at a different location (not shown) and provided to the padding article forming apparatus 100 via an auger conveyor 126.

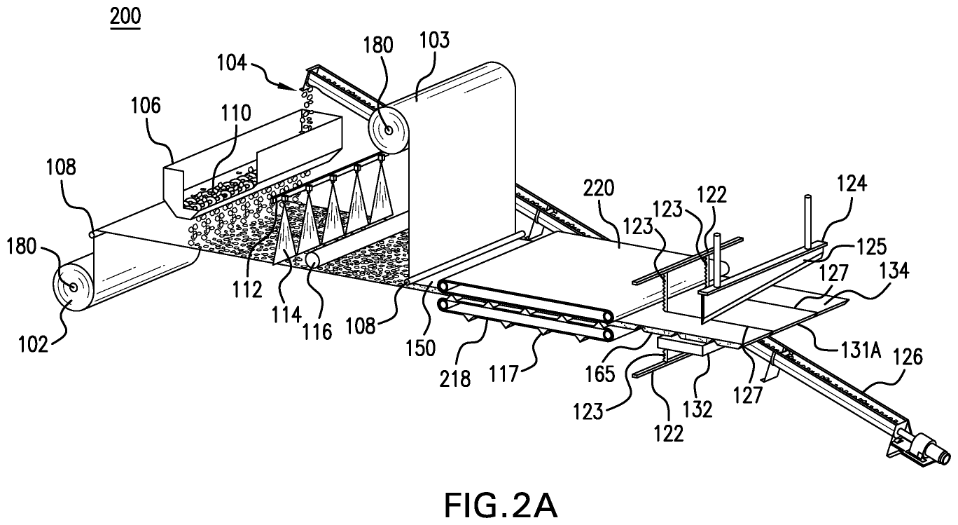

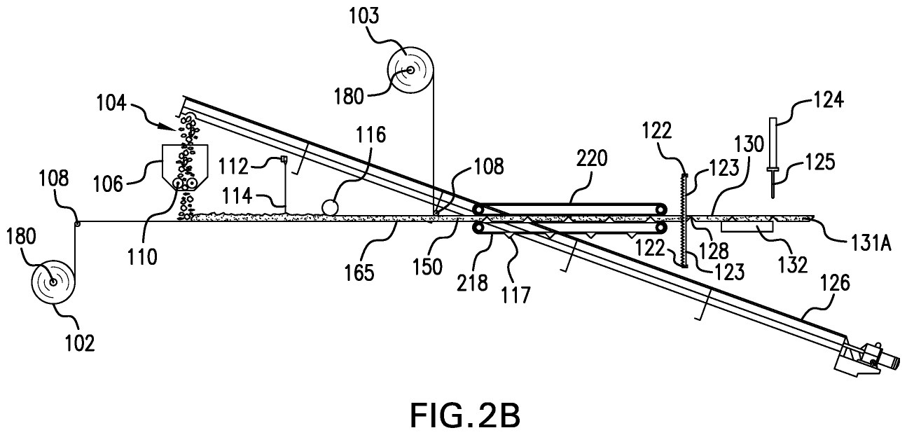

The converted grains 104 exit the converting system, distribution head box 106, onto cover layer 102. In other embodiments, the converted grains 104 exit the converting system onto a conveyor belt in the absence of a cover layer 102. In one embodiment, the converted polymer exits the converting system into a container such as a barrel or vat before being transferred to a further processing apparatus, such as the padding article forming apparatus of FIGS. 1A and 2A.

The cover layer 102 travels longitudinally in the machine direction (shown as the horizontal direction) into the path of an applicator such as a spray head 112, which is configured to spray a bonding agent 114 that evenly coats the surface of the polymer grains 104 on the cover layer 102. In other embodiments, where a bonding agent is not required, the spray head 112 may be absent or switched off. The cover layer 102 is then conveyed beneath a smoothing roller 116 that flattens the coated polymer grains into a layer of substantially uniform thickness. A second cover layer 103 is then placed on top of the coated polymer grains to form a pre-molded padding article 150 comprising bonding agent-coated polymer grains 104/114 sandwiched between two cover layers 102, 103. The cover layers 102, 103 are fed from cover layer supplies, shown here as a rolls 180, around web feeders such as directional rollers 108, that pivot each cover layer 102, 103 from a vertical direction to a horizontal or machine direction.

As depicted in FIGS. 1A and 1B, the pre-molded padding article 150 passes through a molding station that comprises a bottom plate 118 and a top plate 120. One or both of the bottom and top plates 118, 120 are configured to compress the pre-molded padding article 150 between the plates so as to mold transverse indentations 128, thereby creating segments 130 of the resulting padding article. The bottom plate 118 comprises male mold elements 117 such as protrusions or ridges that are shaped to produce the transverse indentations 141. In this embodiment, the male mold elements 117 are v-shaped to provide transverse hinges between the segments. In other embodiment, the male mold elements 117 may be rounded, or other shapes. The distance between the male mold elements 117, is distanced to determine the length of the segments 130. The longitudinal length if the segments is measured from male mold element peak 117 to ridge peak 117. The height of the peak of the male mold elements 117 can be varied depending on the depth of the hinge required. For example, in this embodiment, the male mold element 117 is deep enough to produce an indentation extending through substantially all of the cancellous body 165 so that cover layer 102 is forced into the cancellous body to contact the cover layer 103 on the opposite side of the padding article, as illustrated in FIG. 1C for example. The surface of the top plate 120 is a flat relief surface, however in some embodiments, male mold elements 117 may be on the top plate 120 and the bottom plate 118 may be flat. In other embodiment, both the bottom plate 118 and the top plate 120 have male mold elements 117. In other embodiments, other patterns can be molded into the pre-molded padding article—e.g., longitudinal and/or crisscrossed indentations. In some embodiments, male mold elements 117 can be placed along the longitudinal edge of the mold to provide indentations along the longitudinal edges of the padding articles, giving the padding articles 134 tapered longitudinal edges. The transverse edges are not covered by cover layer, as shown in FIG. 1C and 3B. In this embodiment, the transverse edges are open to atmosphere. In some embodiments, both the longitudinal edges and the transverse edges are covered by cover layer, as shown in FIG. 4A. In this embodiment, the edges are sealed and not open to atmosphere.

In one embodiment, the bottom and top plates 118, 120 are configured to move with the padding article in the machine direction as the segments are molded into the padding article. In other embodiments, the pre-molded padding article 150 remains stationary while the bottom and top plates 118, 120 compress and mold the grains 104 along with the cover layer 103 to shape the padding article 150. In some embodiments, the bottom and top plates 118, 120 are heated to a temperature that allows agglomeration of the grains 104, binding the grains 104 together to form a cancellous structure 165. In other embodiments, the molding station is enclosed in an oven that heats the pad to an agglomeration temperature. The temperature and duration of heating can be adjusted based on the materials and environmental factors. For example, the presence of a binding agent may lower the temperature and/or duration required to cause the grains to agglomerate. Optimal heating conditions will allow the grains 104 to form agglomerates while maintaining an open cell structure within the padding article 150. In other embodiments, the bonding agent 114 causes agglomeration of the grains 104 under pressure caused by the bottom and top plates 118, 120. In other embodiments, the bonding agent 114 does not require heat or pressure to agglomerate the grains 104.

In some embodiments, segmented padding article 150 then passes through a longitudinal cutter 122 that cuts the padding article along lines 127 into two or more panels 134. As depicted, a reciprocal dual-blade 123 longitudinal cutter 122 cuts the molded, segmented padding article 150 into panels 134, each having three segments 130 of equal transverse width. In general, the longitudinal cutter 122 may cut the molded, segmented padding article 150 into panels 134 having two, three, four, five, six, or more segments 130. In some embodiments, the longitudinal cutter may have one, two, three, four, five or more blades 123, and can cut 127 the molded, segmented padding article 150 into two, three, four, five, six, or more panels 134 of equal or varying transverse widths. In other embodiments, the longitudinal cutter 122 may include a circular saw, hot wire cutter, laser, or any other means capable of cutting through the molded, segmented padding article 150.

The panels 134, may then be cut transversely using a transverse cutter 124, shown in this embodiments as a guillotine blade 125 that shears against a block 132 at regular intervals to generate final segmented padding articles 160. Each transverse cut will separate the upstream longitudinal end 131a, 131d of one padding article 134, from the downstream longitudinal end 131b, 131c, 329 of the next padding article 134. In other embodiments, the transverse cutter 124 may include a circular saw, hot wire cutter, laser, or any other means capable of cutting through the molded, segmented padding article 150. In some embodiments, the transverse cutter 124 cuts the panels 134 within the indentations 128 resulting in a padding article with tapered transverse edges 131, as shown in FIG. 1C. In other embodiments, the transverse cutter 124 cuts the panels 134 between indentations to result in a padding article with flat edges 329, 331 as illustrated in FIG. 3B.

FIGS. 2A and 2B illustrate another embodiment of a padding article forming apparatus 200, in which the molding station comprises a bottom compression belt 218 and a top compression belt 220. One or both of the bottom and top compression belts 218, 220 include male mold elements 117, and are configured to compress the pre-molded padding article 150 between the bottom and top compression belts 218, 220 to mold transverse indentations 128, thereby creating segments 130 of the resulting padding article. As described above, the male mold elements 117 are shaped, sized and distances to generate the require size and shape of ridge and the desires longitudinal length of the segments. In other embodiments, other patterns can be molded into the pre-molded padding article—e.g., longitudinal and/or crisscrossed indentations. The bottom and top compression belts 218, 220 are configured to move the padding article in the machine direction. In some embodiments, the bottom and top compression belts 218, 220 are heated to a temperature that allows the grains 104 within the padding article 150 to bond together and form agglomerates. In other embodiments, the bottom and top compression belts 218, 220 are enclosed in an oven that heats the belts to the agglomerate forming temperature. The temperature and duration of heating can be adjusted based on the materials and environmental factors.

FIG. 3A illustrates another embodiment of a padding article forming apparatus 300, which does not include a molding station. Here, after the cover layer 103 is applied over the grains, rollers 390, which may be on the top and/or bottom, move the padding article 150 in the machine direction and through a agglomeration station including bottom 364 and top 362 compression plates that are spring loaded 363, and apply pressure to, and set the thickness of the padding article. One or both of the bottom 364 and top 362 compression plates may include a heating filament 360 that, in combination with the compression provided by the plates 362, 364, act to heat and agglomerate the grains 104 to for the cancellous body 165. Indentations 328 are generated by angled cutters 320, that include adjustable angled blades 321 that move in direct 380. In one embodiment, the indentations are made by forming two 45° chamfers 332 into the upper surface of the padding article to form an approximately 90° indentation 328. The angle of the blades 321 with respect to the padding article can be adjusted to accommodate the speed at which the padding article is moving in the machine direction. As shown, the chamfers 332 are cut through the upper cover layer 103 by, for example, angled cutters 320, leaving the lower cover layer 102 intact to maintain the segments 130 in a connected configuration, as shown in FIG. 3B. Other ways of cutting the indentations may also be also be used, such as those described previously. In addition, rather than a guillotine, the panels 134 may be cut transversely using a rotating blade 324, moving in direction 382, which can cut through the panels 134 at in the segments to produce padding articles with flat transverse edges, as shown in FIG. 3B. Alternatively, the rotating blade can cut within the indentations 328 to form padding articles 134 with tapered edges.

The embodiment illustrated in FIG. 3A also differs from that of the previously described embodiments in that the starting polymer material is provided as a log 302 that is delivered into a polymer processor 310 that converts the starting polymer into grains, such as a plastic granulator or shredder via chute 326. Alternatively, the starting polymer material may be provided as a brick, chunks, strips, or any other conformation that is able to be converted into smaller pieces or grains 104. In other embodiments, the starting polymer material may delivered into the system via a hopper or conveyor belt, or may be manually deposited into the system by a user. The polymer processor 310 is capable of converting the starting polymer into grains with the desired shapes, sizes and size distribution described herein.

In some embodiments, such as that illustrated in of FIG. 3A, the grains and boding agent are mixed together with a mixer 330, such as a mixing wand and/or vibration. In some embodiments, a vibrator 340 is used to distribute the polymer grains into a uniform layer. Other means may be used to mix the grains, such as stirring or whisking, or the grains may not be mixed at all.

In some embodiments, the padding articles 150 may be molded into segmented panels 130 using pressure plates 118, 120 or compression belts 218, 220 as shown in FIGS. 1A and 2A. In other embodiments, the pads are molded using stackable molds made from metal and/or silicon. The molds may be any size or shape required to make the desired size and shape of padding article. The molds may be segmented molds, comprising stackable pans and an optional insert that allows different patterns to be molded into the padding article. In some embodiments, the mold inserts include ridges 117 that are used to mold indentations or hinges in the padding article, for example the ridges 117 could be v-shaped ridges that result in v-shaped indentations or hinges in the padding article, separating the padding article 134 into distinct segments 130 and allowing the padding article to be folded about the v-shaped hinges. The mold insert can either be placed on the bottom of the mold tray or laid over the pad after it has been positioned into the tray. The molds may also include pins to place between the molds when they are stacked to prevent compression between the molds. In addition, the molds may have perforations or air holes to allow air flow between the molds.

In some embodiments, the padding article is positioned into the mold in the bag conformation as described previously or it is constructed in the mold. For example, a cover layer 102, comprising a film or foam sheet can be placed into the mold, followed by the required amount of grains 104, levelled and distributed to the appropriate thickness, followed by a second cover layer 103. In another embodiment, the grains 104 may be placed into the tray and levelled to the appropriate thickness to form a padding article without a cover layer. The cover layers may be added to the padding article at a later stage. The padding article, or components thereof, may fit within the boundaries of the mold tray, or may overlap and spill over the walls of the mold tray and be trimmed to size later.

In some embodiments, the stack of molds containing the padding articles are baked to agglomerate grains 104. In embodiments where the cover layer is present, the cover layer may also adhere to the agglomerates of grains during the baking process. In some embodiments, the padding articles are baked at between 80° C. and 200° C. for between 5 and 90 minutes. In some embodiments, the panels are baked at 90° C. and 150° C. for between 10 and 60 minutes. In one embodiment, the panels are baked at 105° C. for 30 minutes.

In some embodiments, the padding articles are then cooled to room temperature either by turning off the oven and allowing sufficient time to cool, or by transferring them into a cooling device such as a refrigerator or air-conditioned chamber. The amount of time required for cooling varies on the method and materials used.

In some embodiments, as shown in FIG. 4A, the padding article 134 may comprise a metalized cover layer 102 that completely encloses the perimeter of the padding article. The padding article may be tapered on all transverse 199 and longitudinal edges 131. In some embodiments, the padding article 134 includes an imprinted pattern 177 on the segments 130, that may be decorative or be selected for identification purposes. In some embodiments, the pattern 177 is selected to alter cushioning and/or other performance properties.

In some embodiments, the panels are further processed, for example by applying additional cover layers, labels, cutting or shaping, folding and assembling into box configurations, inserting into storage or shipping containers, or assembling as flat pack for distribution. For example, in one embodiment as illustrated in FIG. 4A, two padding articles 134,135 are folded into a c-shape and nested together to make a box shape that can be used to hold products such as food 410. In this embodiment, the edges 131 and 199 of the padding articles 134, 135 are tapered, allowing the edges to fit together closely when the padding articles 134, 135 are nested together. In this embodiment, two rectangular padding articles 134 and 135 are used in combination to form a box shape, whereby each of the two segmented padding articles 134 and 135 is foldable into a C-shape and the two articles are slotted together to form a six-sided box 402, as illustrated in FIGS. 4A and 4B, for example. In the embodiment, the longitudinal edge 131a of the article 134 corresponds to the transverse edge 199e of the article 135, thereby forming a tight seal. Similarly, the transverse edge 199a of the article 134 corresponds to the transverse edge 199d of the article 135, forming a tight seal. Each pair of corresponding edges of the articles 134 and 135 are joined together to form a six-sided box 402. In this embodiment, the tapered edges 131 and 199 are covered by cover layer. In other embodiments, the edges may be flat or some of the edges may be flat and some tapered. In some embodiments, a cooler pack 420 may also be placed inside the padding articles to keep the contents cool. In other embodiments, the panels may be inserted into a similarly shaped outer container 402, such as a cardboard or plastic box. FIG. 4C illustrated a cross-sectional view of padding articles 134, 135 slotted together as in FIG. 4B and inserted into a box 402 for storage or shipments of perishable items 410, which are kept cool by a cooler pack 420. The segments 502, 504, 506, 508, 510, 512 of the padding articles 134, 135, are shaped to match the size of the inner sidewalls 516, 518, 520, 522, 524, 526 of the box 402. When the top pf the box 524 is opened, the segment 502 can also be opened to place or remove contents 410, 420, without having to completely disassemble the container. In other embodiments, a padding article having six segments is provided. The padding article may have a cross shape, four of which are arranged laterally and three of which are arranged vertically such that one segment is shared by the lateral and vertical arrangement. In other embodiments, two padding articles are provided in a manner that the articles, in combination, forms a cube. While the total number of segments of the two padding articles is six, each article can have any of the feasible number of segments.

### EXAMPLES

The disclosed technology is next described by means of the following examples. The use of these and other examples anywhere in the specification is illustrative only, and in no way limits the scope and meaning of the disclosure or of any exemplified form. Likewise, the disclosure is not limited to any particular embodiments described herein. Indeed, modifications and variations of the disclosure may be apparent to those skilled in the art upon reading this specification, and can be made without departing from its spirit and scope. The disclosure is therefore to be limited only by the terms of the claims, along with the full scope of equivalents to which the claims are entitled. All panels described in the following examples are considered representative articles, and comparable results are expected for other types of articles—e.g., other containers, sheets, films, thermoformed parts, fibers, etc. Efforts have been made to ensure accuracy with respect to values presented (e.g., amounts, temperature, etc.), but some experimental error and deviation should be accounted for.

For purposes of the present disclosure and the following examples, thermal insulation performance was evaluated by testing various embodiments of the disclosed padding article under simulated shipping conditions specified by the International Safe Transit Association (ISTA) 7E summer profiles. The ISTA profiles are the global industry standard for thermal transport testing of packing in simulated shipping conditions, and are based on real world transport conditions during summer months. The summer profiles assess performance under high-heat conditions.

### Example 1

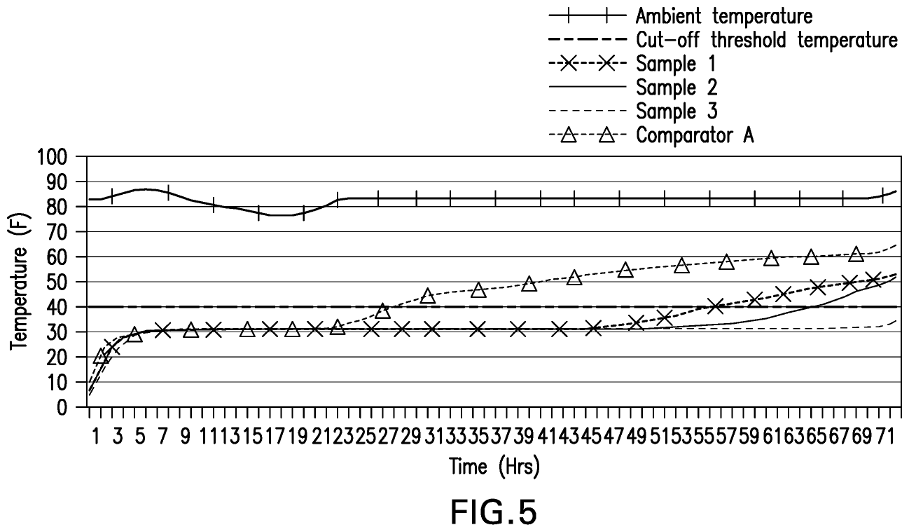

Three representative samples of the presently disclosed padding articles (Samples 1, 2, and 3) were made and subjected to cold chain pack testing, and the results were compared to data corresponding to comparable testing of a paper-based padding article (Comparative Sample A) manufactured by Ranpak. Comparative Sample A comprises a crumpled paper core surrounded by a paper cover layer. Two of the paper-based padding articles are folded into C-shapes and slotted together, and then placed along the interior walls of a six-sided box. A cold pack and a product are then placed inside the lined box, which is then closed, and the interior temperature of the box is monitored. As shown in FIG. 5, Samples 1-3 demonstrated far superior thermal insulation as compared to Comparative Sample A.

Sample 1 comprised padding articles made from polyethylene grains agglomerated using a polyolefin dispersion and surrounded by a polyethylene foam cover layer. Two padding articles were prepared and molded in metal trays to form padding articles having three segments each. The two padding articles were folded into C-shapes and slotted together, and then placed along the interior walls of a six-sided box. A cold pack and a product were then placed inside the lined box, which was then closed, and the interior temperature of the box was monitored. The padding articles of Sample 1 had flat edges, without tapers. As shown in FIG. 5, Sample 1 exhibited dramatically superior results by maintaining the internal temperature of the box below the 40° F. threshold for approximately 56 hours, whereas Comparative Sample A exceeded the 40° F. threshold after just 28 hours.

Sample 2 comprised a padding article made from polyethylene grains agglomerated using a polyolefin dispersion and surrounded by a polyethylene foam cover layer. Two padding articles were prepared and molded in metal trays to form padding articles having three segments each. The two padding articles were folded into C-shapes and slotted together, and then placed along the interior walls of a six-sided box. A cold pack and a product were then placed inside the lined box, which was then closed, and the interior temperature of the box was monitored. The padding articles of Sample 2 had tapered edges. As shown in FIG. 5, Sample 2 exhibited dramatically superior results by maintaining the internal temperature of the box below the 40° F. threshold for approximately 65 hours, whereas Comparative Sample A exceeded the 40° F. threshold after just 28 hours.

Sample 3 comprised a padding article made from polyethylene grains agglomerated using a polyolefin dispersion and surrounded by a metalized polyethylene cover layer. Two padding articles were prepared and molded in metal trays to form padding articles having three segments each. The two padding articles were folded into C-shapes and slotted together, and then placed along the interior walls of a six-sided box. A cold pack and a product were then placed inside the lined box, which was then closed, and the interior temperature of the box was monitored. The padding articles of Sample 1 had tapered edges. As shown in FIG. 5, Sample 3 exhibited dramatically superior results by maintaining the internal temperature of the box below the 40° F. threshold for more than 72 hours—a more than 2.5-fold improvement over Comparative Sample A, which exceeded the 40° F. threshold after just 28 hours.

### Example 2

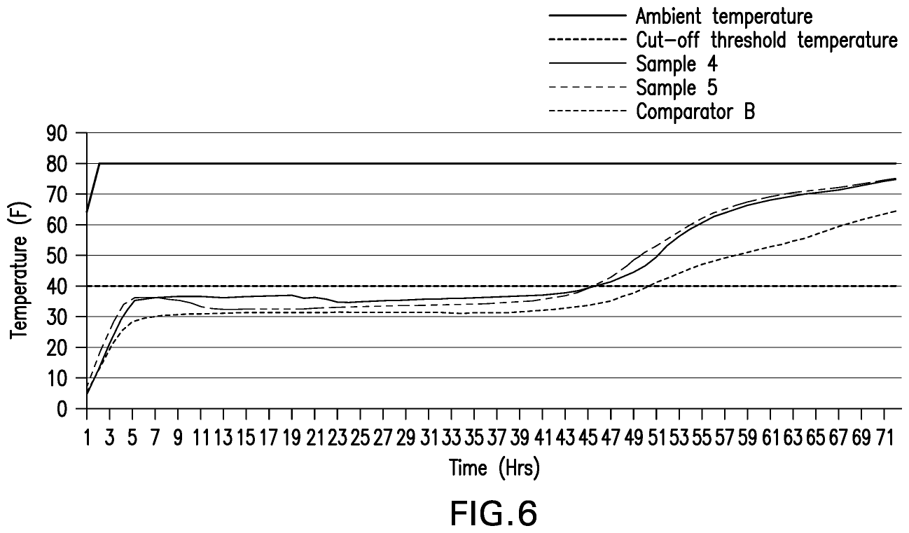

Two representative samples of the presently disclosed lower density padding articles (Samples 4 and 5) were subjected to cold chain pack testing, and the results were compared to data corresponding to comparable testing of a plant-based padding article (Comparative Sample B) manufactured by Temperpack. Comparative Sample B comprises a plant-based core material surrounded by a paper cover layer. Two of the plant-based padding articles are folded into C-shapes and slotted together, and then placed along the interior walls of a six-sided box. A cold pack and a product are then placed inside the lined box, which is then closed, and the interior temperature of the box is monitored. As shown in FIG. 6, Samples 4 and 5 demonstrated far superior thermal insulation as compared to Comparative Sample B.

Sample 4 comprised padding articles made from polyethylene grains agglomerated using a polyolefin dispersion and surrounded by a polyethylene foam cover layer, to form a padding article having a density of 0.00105 lb/sq.in. Two padding articles were prepared and molded in metal trays to form padding articles having three segments each. The two padding articles were folded into C-shapes and slotted together, and then placed along the interior walls of a six-sided box. A cold pack and a product were then placed inside the lined box, which was then closed, and the interior temperature of the box was monitored. The padding articles of Sample 4 had tapered edges. As shown in FIG. 6, Sample 4 exhibited significantly advantageous results by maintaining the internal temperature of the box below the 40° F. threshold for approximately 47 hours, comparable to the duration achieved by Comparative Sample B, which exceeded the 40° F. threshold after 50 hours.

Sample 5 comprised padding articles made from polyethylene grains agglomerated using a polyolefin dispersion and surrounded by a polyethylene foam cover layer, to form a padding article having a density of 0.00084 lb/sq.in. Two padding articles were prepared and molded in metal trays to form padding articles having three segments each. The two padding articles were folded into C-shapes and slotted together, and then placed along the interior walls of a six-sided box. A cold pack and a product were then placed inside the lined box, which was then closed, and the interior temperature of the box was monitored. The padding articles of Sample 5 had tapered edges. As shown in FIG. 6, Sample 5 exhibited significantly advantageous results by maintaining the internal temperature of the box below the 40° F. threshold for approximately 47 hours, comparable to the duration achieved by Comparative Sample B, which exceeded the 40° F. threshold after 50 hours.

The present disclosure is not to be limited in terms of the particular examples described in this application, which are intended as illustrations of various aspects. Many modifications and examples can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and examples are intended to fall within the scope of the appended claims. The present disclosure is to be limited only by the terms of the appended claims, along with the full scope of equivalents to which such claims are entitled. It is also to be understood that the terminology used herein is for describing particular examples only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and examples have been disclosed herein, other aspects and examples will be apparent to those skilled in the art. The various aspects and examples disclosed herein are for purposes of illustration and are not intended to be limiting, with the true scope and spirit being indicated by the following claims.

What is claimed is:

1. A padding article, comprising a cancellous body formed from an agglomeration of grains, wherein the grains are made from a polymer material and are bonded together in a cancellous structure.

2. The padding article of claim 1, wherein the grains are bound together by a bonding agent.

3. The padding article of claim 2, wherein the bonding agent comprises a polyolefin.

4. The padding article of claim 1, wherein the grains are welded together.

5. The padding article of claim 1, wherein the grains in the cancellous structure are in a disordered arrangement.

6. The padding article of claim 1, wherein the cancellous structure is an open cell structure.

7. The padding article of claim 6, wherein the open cell structure includes voids that collectively form channels across the cancellous body.

8. The padding article of claim 1, wherein the polymer material comprises polyolefin.

9. The padding article of claim 8, wherein the polyolefin comprises polyethylene, polypropylene, or a combination thereof.

10. The padding article of claim 1, wherein the grains have a maximum length in a range of about 0.01 inches to about 2 inches.

11. The padding article of claim 1, wherein the cancellous body has a thickness of about 0.05 inches to about 2 inches.

12. The padding article of claim 1, wherein the cancellous body is configured for providing thermal insulation.

13. The padding article of claim 1, wherein the padding article further comprises a cover layer attached to an outer surface of the cancellous body.

14. The padding article of claim 13, wherein the cover layer is attached to the cancellous body by a cover adhesive.

15. The padding article of claim 13, wherein the cancellous body comprises at least two connected segments that are connected to each other via the cover layer, the segments being hinged to pivot with respect to one another.

16. The padding article of claim 13, wherein the cover layer provides a hinge pivotally connecting the segments.

17. The padding article of claim 13, wherein the cancellous body comprises three connected segments that are connected to each other in series via the cover layer, the segments being hinged to pivot with respect to one another.

18. The padding article of claim 17, wherein the segments are pivotally connected in series such that the padding article is configurable into a C-shape.

19. A container system, comprising:
a box having a plurality of sidewalls; and
the padding article according to claim 1 that comprises a first segment that includes at least a portion of the cancellous body that that has a shape closely matching the shape of a first sidewall, such that the first segment is receivable in the box against the first sidewall therein to insulate the first sidewall.

20. The container system of claim 19, wherein:
the padding article further comprises a second segment that includes another segment of the cancellous body adjacent the first segment,
the first and second segments are connected by a hinge, and
the second segment has a shape closely matching the shape of a second sidewall, such that the second segment is receivable in the box against the second sidewall therein to insulate the second sidewall.

21. The container system of claim 20, wherein:
the padding article further comprises a third segment adjacent the second segment,
the second and third segments are connected by a hinge, such that the padding article is configurable into a C-shape, and
the third segment has a shape closely matching the shape of a third sidewall, such that the third segment is receivable in the box against the third sidewall therein to insulate the third sidewall.

22. A method of manufacturing a padding article, comprising the steps of:
distributing grains of a polymer having a maximum length in the range of about 0.01 inches to about 2 inches into a generally uniform layer; and
bonding the grains together to form an agglomeration of the grains arranged as a cancellous body.

23. The method of claim 22, further comprising applying a bonding agent to the grains, wherein grains are bonded together to form the agglomeration using the bonding agent.

24. The method of claim 22, further comprising applying a cover layer to an outer surface of the cancellous body, wherein the cover layer is applied by depositing the grains onto the cover layer and bonding the grains to the cover layer.

25. The method of claim 24, further comprising molding the grains along with the cover layer to shape the padding article to include a plurality of segments that are hinged to each other, each segment including a portion of the cancellous body.

26. An apparatus for manufacturing a padding article, comprising:
a web feeder that feeds a first cover layer in machine direction;
a grain depositor that deposits grains onto the first cover layer being fed by the web feeder;
an bonding device that causes the deposited grains to bond together to form an agglomeration of the grains arranged as a cancellous body; and
a mold that molds the deposited grains on the first cover layer to shape the cancellous body provide the padding article.
